(19) United States
(12) Patent Application Publication
(10) Pub. No.: US 2026/0172193 A1
(43) Pub. Date: Jun. 18, 2026

(54) RADIO RESOURCE CONTROL CONFIGURATION OF SUB-BAND FULL DUPLEX RESOURCES

(71) Applicant: QUALCOMM Incorporated, San Diego, CA (US)

(72) Inventors: Abdelrahman Mohamed Ahmed Mohamed IBRAHIM, San Diego, CA (US); Ahmed Attia ABOTABL, San Diego, CA (US); Muhammad Sayed Khairy ABDELGHAFFAR, San Jose, CA (US)

(21) Appl. No.: 18/979,138

(22) Filed: Dec. 12, 2024

(51) Int. Cl. H04L 5/00; H04L 5/14

(52) U.S. Cl. CPC H04L 5/0053; H04L 5/0092; H04L 5/14

(57) ABSTRACT

Certain aspects of the present disclosure provide techniques for wireless communication. An example method includes receiving, via radio resource control (RRC) signaling, a configuration that indicates a set of UE-side sub-band full duplex (SBFD) resources; and performing an SBFD communication on the set of UE-side SBFD resources. Another example method receiving, via radio resource control (RRC) signaling, a configuration for sub-band full duplex (SBFD) resources, wherein the configuration omits at least one of: a time-domain element of the SBFD resources, or a frequency-domain element of the SBFD resources; and performing, based on whether the UE supports UE-side SBFD communication, a communication in accordance with the configuration

### INTRODUCTION

### Field of the Disclosure

Aspects of the present disclosure relate to wireless communications, and more particularly, to techniques for radio resource control configuration of sub-band full duplex resources.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes receiving, via radio resource control (RRC) signaling, a configuration that indicates a set of UE-side sub-band full duplex (SBFD) resources; and performing an SBFD communication on the set of UE-side SBFD resources.

Certain aspects provide a method for wireless communications by a UE. The method includes receiving, via RRC signaling, a configuration for UE-side SBFD resources, wherein the configuration omits at least one of: a time-domain element of the UE-side SBFD resources, or a frequency-domain element of the UE-side SBFD resources; and performing, based on whether the UE supports UE-side SBFD communication, a communication in accordance with the configuration.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 is a diagram illustrating examples 500, 505, and 510 of full-duplex communication in a wireless network

FIG. 6 is a diagram illustrating an example 600 of network-side SBFD resources 610 and UE-side SBFD resources 620

FIG. 7 is a diagram illustrating an example 700 of a time-domain resource allocation including half-duplex resources 702, network-side SBFD resources 704 (e.g., network-side SBFD resources 610), and UE-side SBFD resources 706 (e.g., UE-side SBFD resources 620)

FIG. 8 is a diagram illustrating an example 800 of configuration of UE-side SBFD resources

FIG. 9 is a diagram illustrating an example 900 of default behavior for an SBFD-aware UE when a configuration of SBFD resources omits a time-domain element or a frequency-domain element

FIG. 10 is a diagram illustrating an example 1000 of default behavior for an SBFD-capable UE when a configuration of UE-side SBFD resources omits a time-domain element or a frequency-domain element

FIG. 11 depicts a method for wireless communications.

FIG. 12 depicts another method for wireless communications.

FIG. 13 depicts aspects of an example communications device.

### DETAILED DESCRIPTION

Aspects of the present disclosure provide apparatuses, methods, processing systems, and computer-readable mediums for radio resource control (RRC) signaling related to indication of resources for user equipment-side sub-band full-duplex communication.

Sub-band full-duplex (SBFD) communication is a type of full-duplex communication in which a communicating bandwidth is divided into one or more uplink sub-bands and one or more downlink sub-bands that do not overlap one another in the frequency domain. SBFD can be supported at a user equipment (UE), a network entity (such as a gNB, a distributed unit, or a radio unit), or both. For example, SBFD may be supported at a network entity (such that the network entity simultaneously performs uplink communication on the one or more uplink sub-bands and downlink communication on the one or more downlink sub-bands) and not at a UE (such that the UE only performs one of uplink communication on the one or more uplink sub-bands or downlink communication on the one or more downlink sub-bands at a given time). In some examples, such a UE may be aware of an SBFD configuration of a resource, and may use only part of the resource for communication by the UE. This is referred to as an SBFD-aware UE. In some other examples, such a UE may not be aware of the SBFD configuration of the resource. For example, such a UE (which may be referred to as a half-duplex UE or a legacy UE) may not support SBFD-related signaling, and may treat the resource as a half-duplex resource. A resource that is configured for SBFD communication may be referred to as an SBFD resource, and may include, for example, a slot or a symbol.

Different UEs may have different capabilities with regard to SBFD communication. A first type of UE may not support simultaneous bidirectional communication in an SBFD resource, and may not support signaling that indicates a resource as an SBFD resource. This first type of UE is referred to herein as a legacy UE, and may only perform half-duplex downlink communication in SBFD resources. A second type of UE may support only unidirectional communication (either uplink communication or downlink communication, referred to as SBFD communication) in an SBFD resource, and may support signaling that indicates a resource as an SBFD resource. This second type of UE is referred to herein as an SBFD-aware UE. A third type of UE may support simultaneous bidirectional communication in SBFD resources, as well as the signaling that indicates a resource as an SBFD resource. This third type of UE is referred to herein as an SBFD-capable UE, and simultaneous bidirectional communication in an SBFD resource by a UE is referred to herein as UE-side SBFD communication. Simultaneous bidirectional communication in an SBFD resource by a network entity is referred to herein as network-side SBFD communication.

In some examples, a UE performing UE-side SBFD communication may create self-interference. For example, a network entity may generally be able to mitigate self-interference by using spatially separated antenna panels and/or sophisticated precoding or beamforming for uplink versus downlink communication. However, the separation of a UE's antenna panels and sophistication of precoding or beamforming are inherently limited by the UE's size, so a UE may suffer more interference during UE-side SBFD communication than a network entity suffers during network-side SBFD communication.

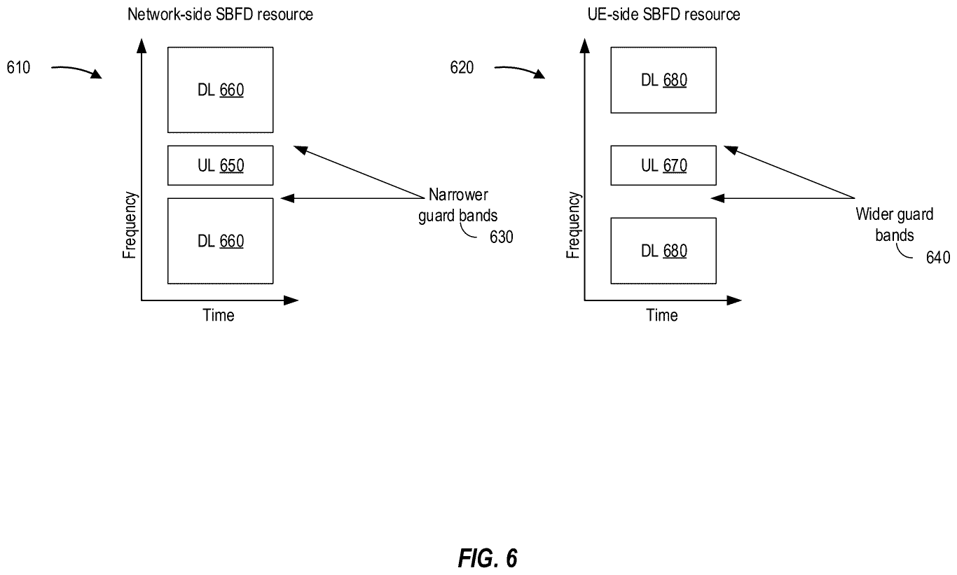

Because of this self-interference issue, it may be beneficial to define network-side SBFD resources with a different structure than UE-side SBFD resources. For example, as illustrated in FIG. 6, a network-side SBFD resource may have a narrower set of guard bands than a UE-side SBFD resource. This may improve spectral efficiency in network-side SBFD resources at the network node, while providing a UE with sufficient guard band separation to mitigate self-interference in UE-side SBFD resources.

Issues may arise with the implementation of UE-side SBFD resources. For example, no mechanism may be defined for a network entity to signal an indication of UE-side SBFD resources to a UE. Thus, ambiguity may arise with regard to how to signal time and frequency (time/frequency) resources for UE-side SBFD resources to an SBFD-capable UE. As another example, it may be unclear whether UE-side SBFD operation is supported only in an RRC connected mode or also in an RRC inactive mode, which affects viable forms of signaling of UE-side SBFD resources. Still further, interaction between resources already configured as network-side SBFD resources, and indication of resources as UE-side SBFD resources, may be unclear. Finally, in some examples, network signaling that indicates network-side or UE-side SBFD resources may omit one or more of a frequency-domain element (e.g., an element that indicates frequency domain resources as UE-side SBFD resources) or a time-domain element (e.g., an element that indicates time-domain resources as UE-side SBFD resources). UE behavior in such a scenario may be unclear, particularly when both SBFD-aware and SBFD-capable UEs can coexist.

Aspects of the present disclosure relate generally to signaling of UE-side SBFD resources. Some aspects more specifically relate to indication of a UE-side SBFD resource to an SBFD-capable UE using cell-specific signaling, UE-specific signaling, or a combination thereof. Some aspects provide clarification of whether UE-side SBFD communication is applicable for RRC connected mode UEs, RRC idle or inactive mode UEs, or a combination thereof. Some aspects provide default behaviors for SBFD-aware UEs in the case when a configuration of network-side SBFD resources (which are not supported for UE-side SBFD communication by the SBFD-aware UE) omits one or more of a time-domain element or a frequency-domain element. Some aspects provide default behaviors for SBFD-capable UEs in the case when a configuration of UE-side SBFD resources (which are not supported for UE-side SBFD communication by the SBFD-aware UE) omits one or more of a time-domain element or a frequency-domain element.

Aspects of the present disclosure may be used to realize one or more of the following potential advantages. In some aspects, by providing indication of a UE-side SBFD resource to an SBFD-capable UE using cell-specific signaling, network overhead is reduced and a baseline UE-side SBFD resource configuration can be provided to all UEs of a cell. By providing indication of the UE-side SBFD resource using UE-specific signaling, increased network flexibility is provided and resource configurations can be tailored to individual UEs or groups of UEs. By providing initial indication via cell-specific signaling and later modification via UE-specific signaling, a balance is achieved between cell-level efficiency and flexibility of configuration.

By providing clarification of whether UE-side SBFD communication is applicable for RRC connected mode UEs, RRC idle or inactive mode UEs, or a combination thereof, aspects enable definition of RRC signaling to support indication of UE-side SBFD communication. By providing default behaviors for SBFD-aware UEs in the case when a configuration of UE-side SBFD resources (which are not supported for UE-side SBFD communication by the SBFD-aware UE) omits one or more of a time-domain element or a frequency-domain element, these elements can be omitted from the configuration in some cases while maintaining predictability of UE behavior, thereby decreasing overhead and improving compatibility with SBFD-aware UEs. By providing default behaviors for SBFD-capable UEs in the case when a configuration of UE-side SBFD resources (which are supported for UE-side SBFD communication by the SBFD-capable UE) omits one or more of a time-domain element or a frequency-domain element, these elements can be omitted from the configuration in some cases while maintaining predictability of UE behavior, thereby decreasing overhead and improving compatibility with SBFD-capable UEs.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

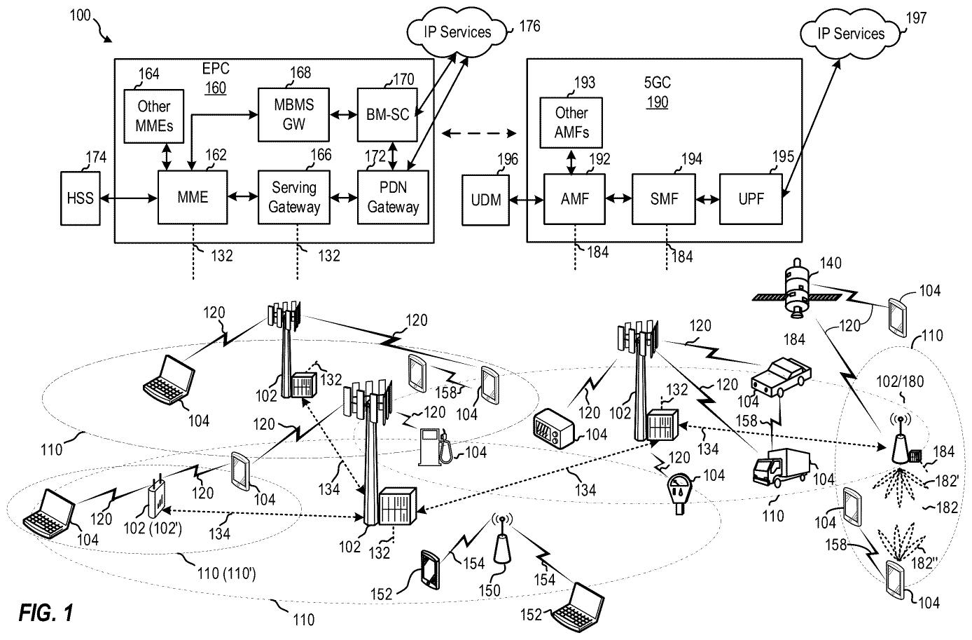

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

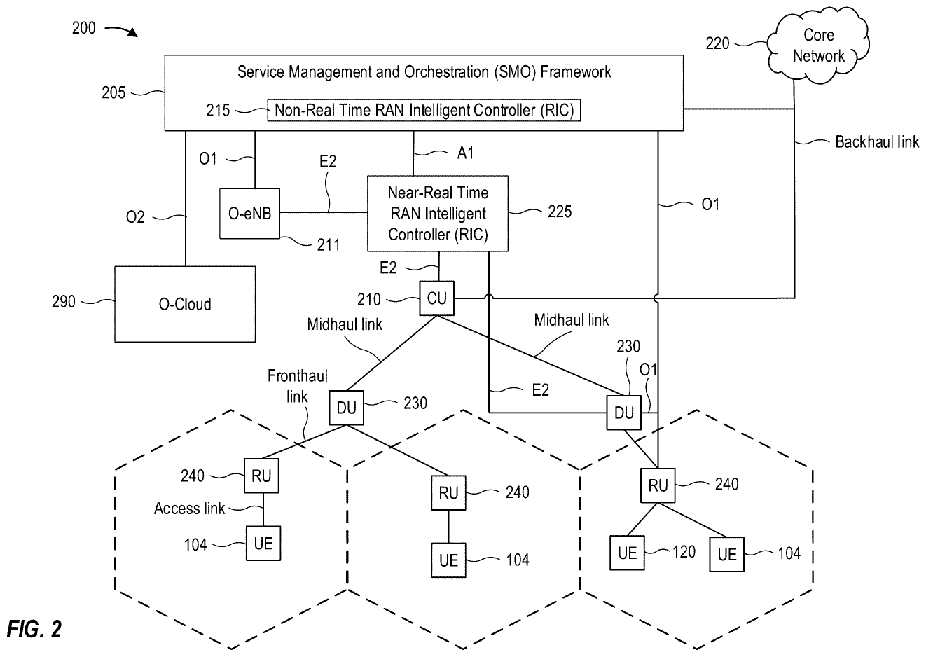

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1 ) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit - Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

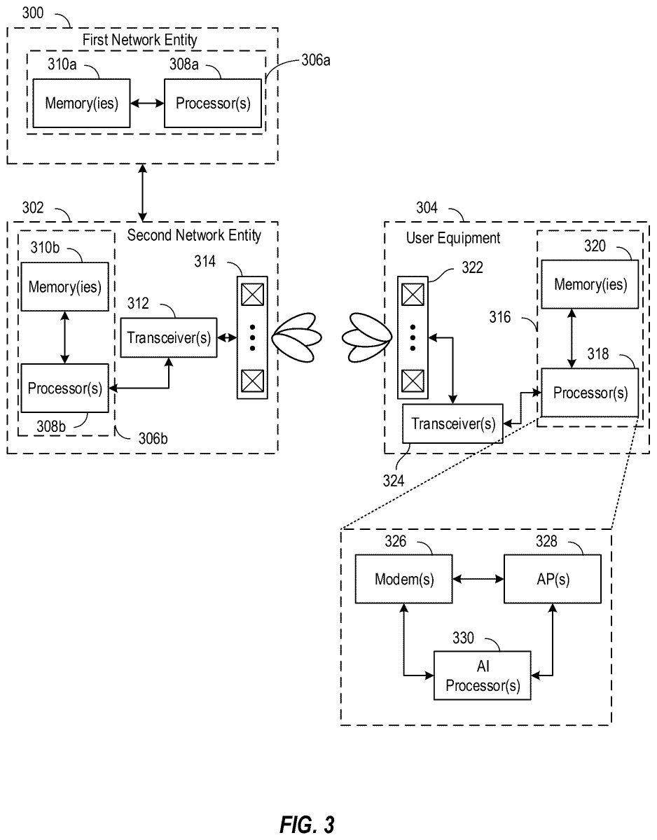

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

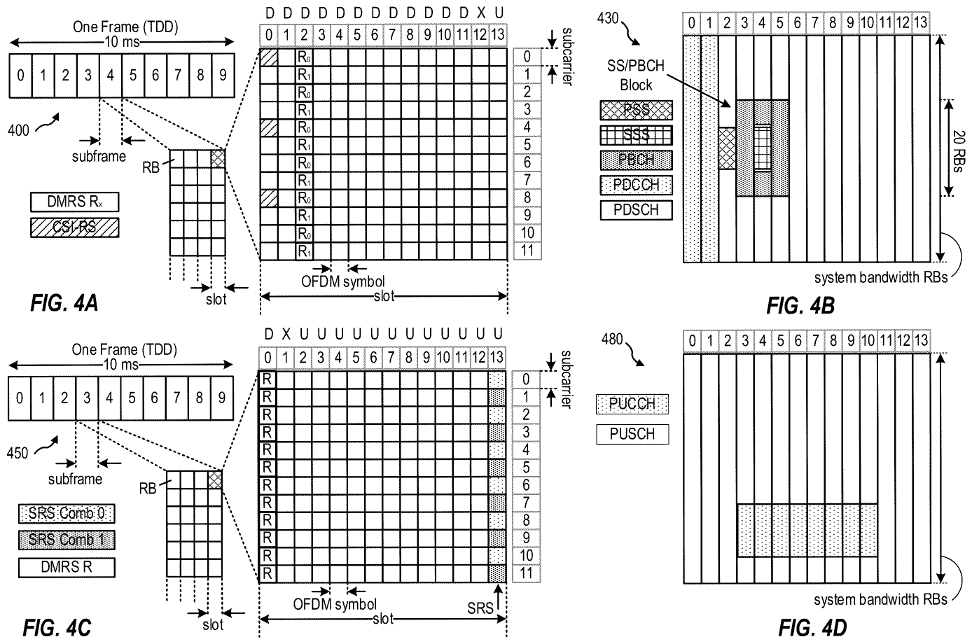

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

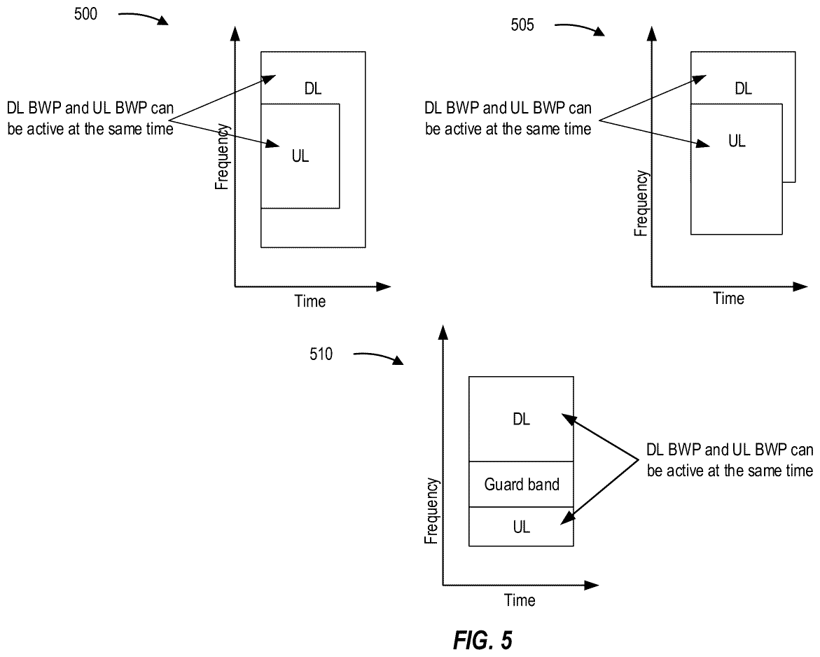

FIG. 5 is a diagram illustrating examples 500, 505, and 510 of full-duplex communication in a wireless network such as wireless communication network 100. “FD communication” in a wireless network refers to simultaneous bi-directional communication between devices in the wireless network. For example, a UE operating in a full-duplex mode may transmit an uplink communication and receive a downlink communication at the same time (for example, in the same slot or the same symbol). “HD communication” in a wireless network refers to unidirectional communications (for example, only downlink communication or only uplink communication) between devices at a given time (for example, in a given slot or a given symbol).

As shown in FIG. 5, examples 500 and 505 show examples of in-band full-duplex (IBFD) communication. In IBFD, a UE (such as UE 104 or UE 304) may transmit an uplink communication to a network entity (and receive a downlink communication from the base station on the same time and frequency resources. As shown in example 500, in a first example of IBFD, the time and frequency resources for uplink communication may fully overlap with the time and frequency resources for downlink communication. As shown in example 505, in a second example of IBFD, the time and frequency resources for uplink communication may partially overlap with the time and frequency resources for downlink communication.

As further shown in FIG. 5, example 510 shows an example of SBFD communication, which may also be referred to as “sub-band frequency division duplex (SBFDD)” or “flexible duplex.” In SBFD, a UE may transmit an uplink communication to a base station and receive a downlink communication from the base station at the same time, but on different frequency resources. For example, the different frequency resources may be sub-bands of a frequency band, such as a time division duplexing (TDD) band. In this case, the frequency resources used for downlink communication may be separated from the frequency resources used for uplink communication, in the frequency domain, by a guard band. A guard band is a set of resources (such as a set of resource blocks or a sub-band) in which a UE is not expected to transmit or receive communications. A guard band mitigates self-interference at a UE due to transmission in an uplink sub-band while receiving in a downlink sub-band.

SBFD may increase an uplink duty cycle, improve uplink coverage, and reduce latency, because it is possible to transmit an uplink signal in an uplink sub-band in downlink only or in flexible slots. SBFD may enhance system capacity, resource utilization, and spectrum efficiency. SBFD may enable flexible and dynamic uplink and downlink resource adaption according to uplink and downlink traffic in a robust manner.

As indicated above, FIG. 5 is provided as an example. Other examples may differ from what is described with respect to FIG. 5.

FIG. 6 is a diagram illustrating an example 600 of network-side SBFD resources 610 and UE-side SBFD resources 620. As shown by reference number 630, the network-side SBFD resources 610 may have a first guard band width (e.g., a first bandwidth). As shown by reference number 640, the UE-side SBFD resources 620 may have a second guard band width (e.g., a second bandwidth). The first guard band width is narrower than the second guard band width. The first guard band width improves spectral efficiency at a network entity performing SBFD communications. The second guard band width reduces self-interference at an SBFD-capable UE that is performing UE-side SBFD communication in a UE-side SBFD resource.

The network-side SBFD resources 610 include an uplink sub-band 650 and a set of downlink sub-bands 660. The UE-side SBFD resources 620 include an uplink sub-band 670 and a set of downlink sub-bands 680. In some aspects, an uplink sub-band 670 has a first bandwidth narrower than a second bandwidth of an uplink sub-band 650 (e.g., due to the narrower guard bands of the network-side SBFD resources 610). In some aspects, a downlink sub-band 680 has a first bandwidth narrower than a second bandwidth of a downlink sub-band 660 (e.g., due to the narrower guard bands of the network-side SBFD resources 610).

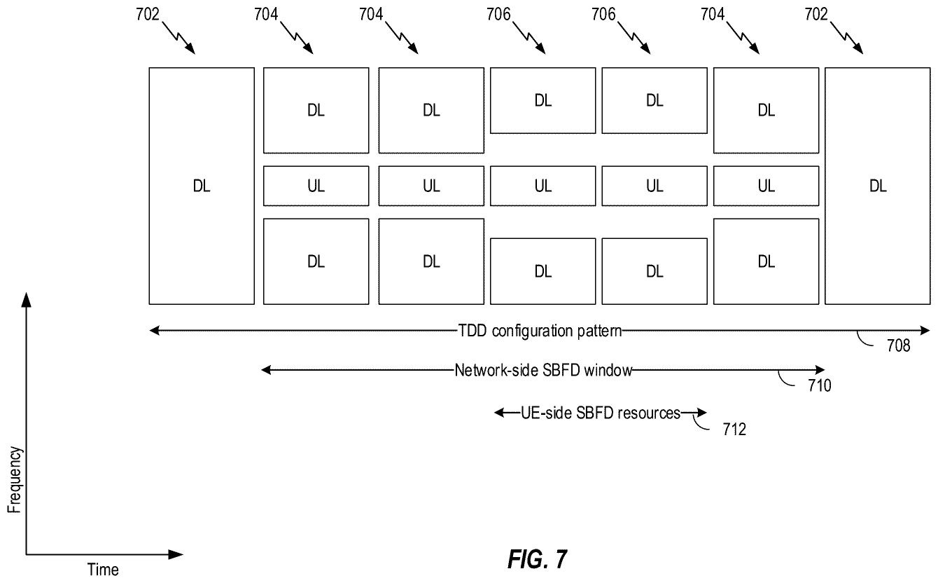

FIG. 7 is a diagram illustrating an example 700 of a time-domain resource allocation including half-duplex resources 702, network-side SBFD resources 704 (e.g., network-side SBFD resources 610), and UE-side SBFD resources 706 (e.g., UE-side SBFD resources 620). The time-domain resource allocation may include a series of symbols (e.g., OFDM symbols), a series of slots, or the like.

In some aspects, a TDD configuration pattern 708 (e.g., a configuration TDD-UL-DL-ConfigCommon or TDD-UL-DL-ConfigDedicated) may initially indicate time-domain resources 702/704/706 as downlink (D), uplink (U), or flexible (F) resources. A D resource is a resource in which downlink (half-duplex) communication is permitted. A U resource is a resource in which uplink (half-duplex) communication is permitted. An F resource is a resource in with either downlink or uplink communication is permitted, and an F resource can later be indicated as a D resource or a U resource.

A half-duplex resource 702 that is a D resource or an F resource can be subsequently indicated as a network-side SBFD resource 704. For example, a signaling from a network entity may indicate a network-side SBFD window 710. SBFD-aware UEs and SBFD-capable UEs may receive this signaling and identify resources 704 and 706 as network-side SBFD resources. Thus, an SBFD-aware UE can perform SBFD communication (that is, either uplink communication in an uplink sub-band or downlink communication in a downlink sub-band) in network-side SBFD resources 704 in the network-side SBFD window 710. Note that, at this point, the UE-side SBFD resources 706 have not been indicated. An SBFD-capable UE may also perform SBFD communication in these network-side SBFD resources. However, in some aspects, the narrower guard bands of the network-side SBFD resources may mean that UE-side SBFD communication in a network-side SBFD resource 704 leads to untenable self-interference at an SBFD-capable UE.

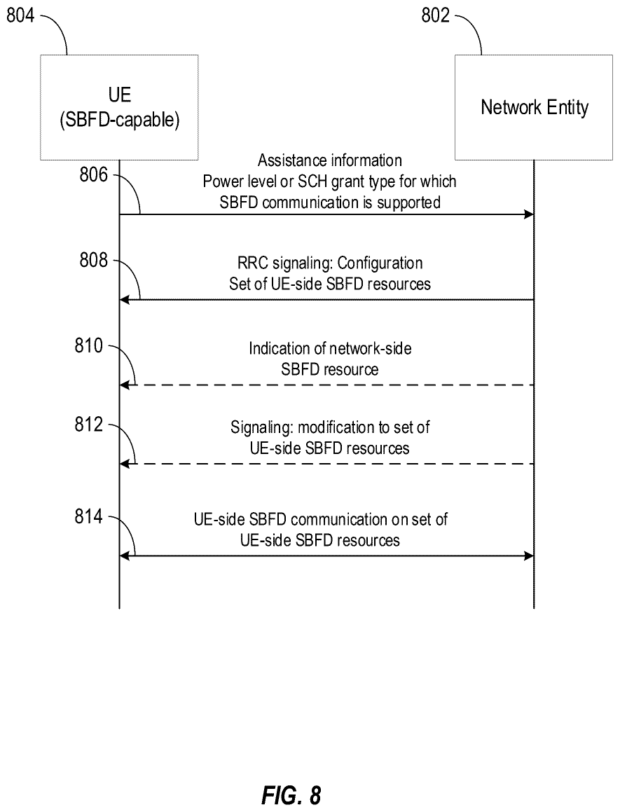

Within the network-side SBFD window 710, one or more network-side SBFD resources 704 can be indicated as UE-side SBFD resources 706. For example, these UE-side SBFD resources 706 may be included in a window 712. Aspects described herein provide RRC signaling that indicates the window 712, such as RRC signaling that indicates which resources are UE-side SBFD resources 706. In some examples, an SBFD-aware UE may perform SBFD communication (unidirectional SBFD communication) in a UE-side SBFD resource 706. In some examples, an SBFD-aware UE may not receive or understand signaling that indicates a network-side SBFD resource 704 as a UE-side SBFD resource 706. FIG. 8 provides examples of configuration of UE-side SBFD resources 706.

FIG. 8 is a diagram illustrating an example 800 of configuration of UE-side SBFD resources (such as UE-side SBFD resources 706). Example 800 includes a network entity 802 and a UE 804. In some aspects, the network entity 802 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 804 may be an example of UE 104 depicted and described with respect to FIG. 1 or the UE 304 depicted and described with respect to FIG. 3. However, in other aspects, UE 804 may be another type of wireless communications device and network entity 802 may be another type of network entity or network node, such as those described herein. Note that any operations or signaling illustrated with dashed lines may indicate that that operation or signaling is an optional or alternative example.

The UE 804 is an SBFD-capable UE. An SBFD-capable UE is capable of performing UE-side SBFD communication (e.g., simultaneous bidirectional communication) in a UE-side SBFD resource 706, and of understanding signaling that indicates resources as network-side SBFD resources 704 or UE-side SBFD resources 706. In some aspects, an SBFD-capable UE may support improved spatial isolation (e.g., separate transmit and receive antennas or panels, or a single shared antenna with enhanced circulator and/or duplexer design) relative to an SBFD-aware UE. In some aspects, an SBFD-capable UE may support improved frequency isolation (e.g., a transmit/receive analog filter or duplexer) relative to an SBFD-aware UE. In some aspects, an SBFD-capable UE may support an analog interference canceller, a receive filter, a digital non-linear interference canceller (e.g., using kernel generation from transmit samples and/or a feedback receiver to capture post-power-amplifier non-linearity).

In some aspects, the UE 804 is in an RRC connected mode. For example, the UE 804 may have an active connection with the network entity 802. In some aspects, UE-side SBFD communication is supported in the RRC connected mode. For example, the UE 804 may perform at least some of the operations of FIG. 8 while the UE 804 is in an RRC connected mode.

In some aspects, the UE 804 is in an RRC inactive mode or an RRC idle mode. For example, the UE 804 may have moved to the RRC inactive mode from an RRC connected mode. The UE 804 may receive paging, synchronization signal block transmissions, tracking reference signals. In some aspects, the UE 804 may support UE-side SBFD communication in the RRC inactive mode. For example, the UE 804 may perform at least some of the operations of example 800 while in the RRC inactive mode (such as the UE-side SBFD communication). In some aspects, the UE-side SBFD communication of example 800, while the UE 804 is in the RRC inactive mode, may include a small data transmission (SDT) configured grant (CG) transmission that is simultaneous with paging, SSB, or TRS reception.

At 806, in some aspects, the UE 804 may transmit, and the network entity 802 may receive, assistance information. The UE 804 may transmit the assistance information via any suitable form of signaling, such as UE assistance information signaling, uplink control information, an uplink shared channel, or the like. The assistance information may include information regarding an SBFD capability of the UE 804. For example, the assistance information may indicate a power level at which SBFD communication is supported (e.g., the assistance information may indicate that UE-side SBFD communication is supported at one or more transmit power levels). As another example, the assistance information may indicate a shared channel (SCH) grant type for which SBFD communication is supported (e.g., the assistance information may indicate that UE-side SBFD communication is supported or a dynamic grant physical uplink shared channel (PUSCH), a configured grant PUSCH, or a combination thereof. In some aspects, the network entity 802 may generate or adjust a configuration 808 that indicates a set of UE-side SBFD resources according to the assistance information. For example, based on the assistance information, the network entity 802 may adjust a number of UE-side SBFD resources or downlink/uplink scheduling on the number of UE-side SBFD resources, as described in more detail at 812.

As shown, the network entity 802 may transmit, and the UE 804 may receive, a configuration 808. For example, the configuration 808 may be transmitted via RRC signaling. The configuration 808 indicates a set of UE-side SBFD resources, such as UE-side SBFD resources 706 or UE-side SBFD resources 620. In some aspects, the configuration 808 indicates a window 712. Thus, the configuration 808 indicates time-domain resources for the set of UE-side SBFD resources. In some aspects, the configuration 808 indicates a time-domain pattern for a set of UE-side SBFD resources. For example, the configuration 808 may indicate a recurring pattern that identifies the set of UE-side SBFD resources, a set of resources of a TDD configuration pattern 708 or network-side SBFD window 710 that are configured as UE-side SBFD resources, or the like. The configuration 808 may additionally or alternatively indicate frequency-domain resources for the set of UE-side SBFD resources, such as a set of sub-bands for the set of UE-side SBFD resources.

In some aspects, the configuration 808 is transmitted via cell-specific signaling (e.g., for an inactive mode UE and/or a connected mode UE). For example, the configuration 808 may be transmitted via a common RRC parameter (e.g., a parameter UE-SBFD-ConfigCommon), such as via system information. As another example, a plurality of SBFD-capable UEs (e.g., all SBFD-capable UEs of a cell) may have the same configuration 808, whether the configuration 808 is transmitted via UE-specific RRC signaling or cell-specific RRC signaling. In this example, in some aspects, the network entity 802 may configure all SBFD-capable UEs associated with the network entity to use the same resource(s) as UE-side SBFD resources.

In some aspects, the cell-specific signaling may indicate a set of UE-side resources, and subsequent UE-specific signaling (such as at 812) may modify the set of UE-side resources. For example, the subsequent UE-specific signaling may indicate additional UE-side SBFD resources, may modify a guard band of a UE-side SBFD resource (e.g., according to a capability or assistance information of a UE 804), or the like. In some aspects, the subsequent UE-specific signaling may indicate a UE-specific guard band. For example, the subsequent UE-specific signaling may indicate a guard band specific to a UE 804 (such as according to a capability or assistance information of the UE 804).

In some aspects, the configuration 808 is transmitted via UE-specific signaling such as a UE-specific configuration (e.g., for a connected mode UE). For example, the configuration 808 may be transmitted via a serving cell configuration, such as a dedicated configuration parameter (e.g., UE-SBFD-ConfigDedicated or UE-SBFD-TD-ConfigDedicated) of the serving cell configuration. The UE-specific signaling may provide increased flexibility, may make better use of UE capabilities, and may distribute SBFD-capable UEs over time (or concentrate the SBFD-capable UEs on certain resources). In some aspects, the dedicated configuration parameter may be defined based on an information element indicating a time-domain pattern for a network-side SBFD resource.

In some aspects, at 810, the network entity 802 may transmit, and the UE 804 may receive, an indication of network-side SBFD resources (e.g., network-side SBFD resources 610 or 704). In some aspects, the UE 804 receives the indication prior to the configuration 808. For example, the configuration 808 may indicate which network-side SBFD resources, indicated by the indication of network-side SBFD resources, are considered UE-side SBFD resources. In some aspects, the UE 804 may perform SBFD communication on the network-side SBFD resources, and may perform (at 814) UE-side SBFD communication on the UE-side SBFD resources.

In some aspects, at 812, the network entity 802 transmits, and the UE 804 receives, signaling that indicates a modification to a set of UE-side SBFD resources indicated by the configuration 808. For example, the modification may add additional UE-side SBFD resources to the set of UE-side SBFD resources. As another example, the modification may redefine a network-side SBFD resource as a UE-side SBFD resource (such as by changing a guard band or sub-band width of the network-side SBFD resource). As another example, the modification may change a frequency resource of a UE-side SBFD resource. As another example, the modification may redefine a UE-side SBFD resource to be a network-side SBFD resource. In some aspects, as mentioned, the modification may be based on assistance information transmitted by the UE 804 at 806. In some aspects, the signaling that indicates the modification may comprise RRC reconfiguration signaling. In some aspects, the signaling that indicates the modification may include MAC signaling (such as a MAC control element) or downlink control information. For example, a MAC-CE or DCI may be used to adjust a UE-side SBFD resource (such as a time-domain pattern indicated by the configuration 808).

At 814, the UE 804 (and optionally the network entity 802) may perform UE-side SBFD communication on the set of UE-side SBFD resources. For example, the UE 804 may simultaneously transmit an uplink communication on an uplink sub-band of the set of UE-side SBFD resources and receive a downlink communication on a downlink sub-band of the set of UE-side SBFD resources. As another example, the UE 804 may perform an SDT CG transmission that is simultaneous with paging, SSB, or TRS reception.

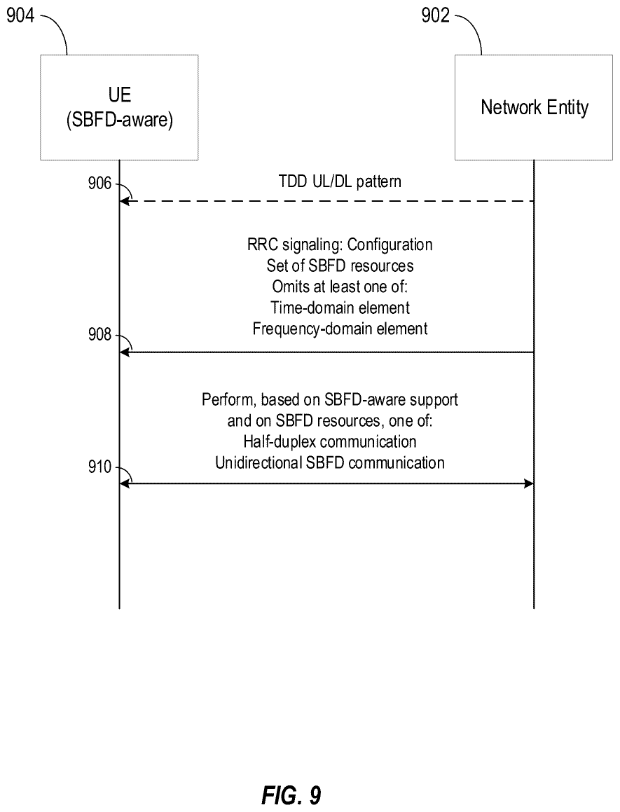

FIG. 9 is a diagram illustrating an example 900 of default behavior for an SBFD-aware UE when a configuration of SBFD resources omits a time-domain element or a frequency-domain element. Example 900 includes a network entity 902 and a UE 904. In some aspects, the network entity 902 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 904 may be an example of UE 104 depicted and described with respect to FIG. 1 or the UE 304 depicted and described with respect to FIG. 3. However, in other aspects, UE 904 may be another type of wireless communications device and network entity 902 may be another type of network entity or network node, such as those described herein. Note that any operations or signaling illustrated with dashed lines may indicate that that operation or signaling is an optional or alternative example.

In example 900, the UE 904 is an SBFD-aware UE. An SBFD-aware UE can understand signaling that indicates a resource as a network-side SBFD resource. An SBFD-aware UE can communicate in a network-side SBFD resource by performing SBFD communication, such as one of an uplink transmission in an uplink sub-band of the network-side SBFD resource or a downlink reception in a downlink sub-band of the network-side SBFD resource.

In some aspects, the network entity 902 may transmit, and the UE 904 may receive, a TDD UL/DL pattern 906 (e.g., TDD configuration pattern 708). The TDD UL/DL pattern 906 may indicate whether certain resources are U resources, D resources, or F resources, as described with respect to FIG. 7.

As shown, the network entity 902 may transmit, and the UE 904 may receive, a configuration 908 that includes an indication of a set of SBFD resources. In some aspects, the configuration 908 may indicate the set of SBFD resources as a set of network-side SBFD resources. In some aspects, the configuration 908 may indicate the set of SBFD resources as a set of UE-side SBFD resources. In some aspects, the configuration 908 omits a time-domain element of the set of SBFD resources. For example, the configuration 908 may omit information that indicates particular symbols or slots configured as SBFD resources. Additionally, or alternatively, the configuration 908 may omit a frequency-domain element of the set of SBFD resources. For example, the configuration 908 may omit information that indicates frequency locations of uplink sub-bands, downlink sub-bands, guard bands, or a combination thereof.

As shown, at 910, the UE 904 performs a communication (that is, one of half-duplex communication or unidirectional SBFD communication). For example, in some aspects the UE 904 may treat the SBFD resources as half-duplex resources (that is, not indicated as an SBFD resource). Alternatively, the UE 904 may treat the SBFD resources as SBFD resources, and may perform SBFD communication in the SBFD resources. In some aspects, whether the UE 904 performs half-duplex communication or SBFD communication is based on whether the UE 904 has received a TDD UL/DL pattern 906. In some aspects, the UE 904 determines an error case based on the configuration 908 omitting the time-domain element and/or the frequency-domain element. Particular examples of all these aspects are provided below.

In some aspects, the configuration 908 indicates a time-domain element and not a frequency-domain element. In such aspects, in some cases, the UE 904 may perform half-duplex communication. For example, the UE 904 may perform no SBFD operation if the configuration 908 indicates a time-domain element (e.g., resource) and not a frequency-domain element. Alternatively, in some cases, the UE 904 may perform SBFD communication in resources indicated by the time-domain element. For example, the UE 904 may perform the SBFD communication (e.g., SBFD operation) in the indicated time resources according to a set of default frequency-domain sub-bands. These default frequency-domain sub-bands may be indicated in a wireless communication specification or otherwise pre-defined. Alternatively, the UE 904 may perform the half-duplex communication based on an error case. For example, the UE 904 may determine an error case when the time-domain element is indicated and not the frequency-domain element.

In some aspects, the configuration 908 indicates a frequency-domain element and not a time-domain element, and the UE 904 has received the TDD UL/DL pattern 906. In such aspects, in some cases, the UE 904 may perform half-duplex communication. For example, the UE 904 may perform no SBFD operation if the configuration 908 indicates a frequency-domain element (e.g., sub-band) and not a time-domain element (e.g., slots and/or symbols). Alternatively, in some cases, the UE 904 may perform SBFD communication in resources indicated by the frequency-domain element. As a first example, the UE 904 may perform the SBFD communication (e.g., SBFD operation) according to the indicated frequency-domain element in resources indicated as downlink resources by the TDD UL/DL pattern 906. As a second example, the UE 904 may perform the SBFD communication (e.g., SBFD operation) according to the indicated frequency-domain element in resources indicated as flexible resources by the TDD UL/DL pattern 906. As a third example, the UE 904 may perform the SBFD communication (e.g., SBFD operation) according to the indicated frequency-domain element in resources indicated as flexible resources or downlink resources by the TDD UL/DL pattern 906. As a fourth example, the UE 904 may perform the SBFD communication (e.g., SBFD operation) according to the indicated frequency-domain element in a default time window. For example, the default time window may be a function of the TDD UL/DL pattern 906 (e.g., a last three resources indicated by the TDD UL/DL pattern 906 may be considered SBFD resources as just one example). Alternatively, in some cases, the UE 904 may determine an error case when the configuration 908 indicates the time-domain element, omits the frequency-domain element, and the UE 904 has received the TDD UL/DL pattern 906.

In some aspects, the configuration 908 indicates a frequency-domain element and not a time-domain element, and the UE 904 has not received the TDD UL/DL pattern 906. In such aspects, in some cases, the UE 904 may perform half-duplex communication. For example, the UE 904 may perform no SBFD operation if the configuration 908 indicates a frequency-domain element (e.g., sub-band) and not a time-domain element (e.g., slots and/or symbols). Alternatively, in some cases, the UE 904 may perform SBFD communication in resources indicated by the frequency-domain element in any available slot or symbol.

In some aspects, the configuration 908 indicates neither the time-domain element nor the frequency-domain element. For example, the UE 904 may not receive the configuration 908. In such aspects, in some cases, the UE 904 may perform half-duplex communication. For example, the UE 904 may perform no SBFD operation (and may use a legacy TDD configuration) if the UE 904 receives a configuration 908 that indicates neither time-domain elements nor frequency-domain elements for an SBFD resource, or if the UE 904 receives no configuration 908. Alternatively, the UE 904 may perform SBFD communication. As a first example, the UE 904 may perform the SBFD communication (e.g., SBFD operation) according to the indicated frequency-domain element in resources indicated as downlink resources by the TDD UL/DL pattern 906. As a second example, the UE 904 may perform the SBFD communication (e.g., SBFD operation) according to the indicated frequency-domain element in resources indicated as flexible resources by the TDD UL/DL pattern 906. As a third example, the UE 904 may perform the SBFD communication (e.g., SBFD operation) according to the indicated frequency-domain element in resources indicated as flexible resources or downlink resources by the TDD UL/DL pattern 906. As a fourth example, the UE 904 may perform the SBFD communication (e.g., SBFD operation) according to the indicated frequency-domain element in a default time window. For example, the default time window may be a function of the TDD UL/DL pattern 906 (e.g., a last three resources indicated by the TDD UL/DL pattern 906 may be considered SBFD resources as just one example). In the frequency domain, the UE 904 may perform the SBFD communication according to a default frequency pattern (e.g., a set of sub-bands). For example, the default frequency pattern may be indicated in a wireless communication specification.

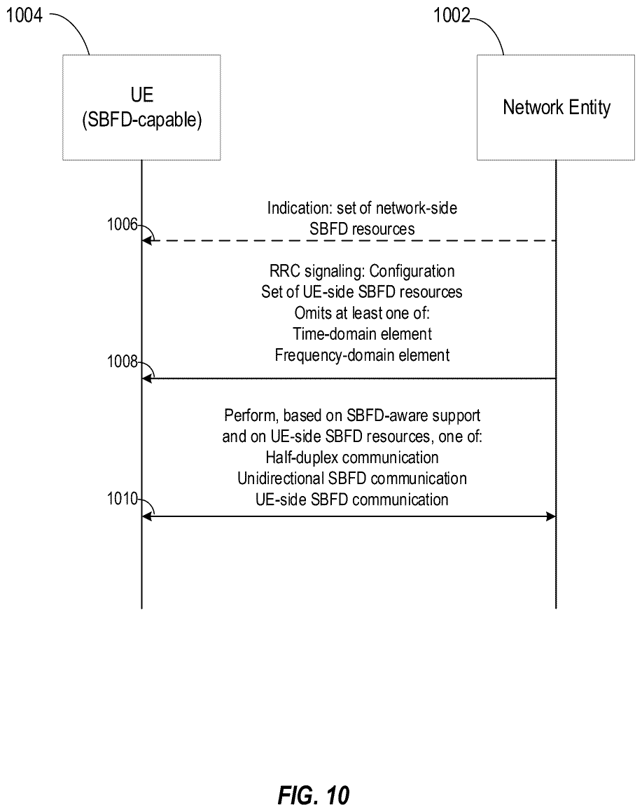

FIG. 10 is a diagram illustrating an example 1000 of default behavior for an SBFD-capable UE when a configuration of UE-side SBFD resources omits a time-domain element or a frequency-domain element. Example 1000 includes a network entity 1002 and a UE 1004. In some aspects, the network entity 1002 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 1004 may be an example of UE 104 depicted and described with respect to FIG. 1 or the UE 304 depicted and described with respect to FIG. 3. However, in other aspects, UE 1004 may be another type of wireless communications device and network entity 1002 may be another type of network entity or network node, such as those described herein. Note that any operations or signaling illustrated with dashed lines may indicate that that operation or signaling is an optional or alternative example. In example 1000 of FIG. 10, the UE 1004 is an SBFD-capable UE, as described with regard to the UE 804 of FIG. 8.

As shown, the network entity 1002 may transmit, and the UE 1004 may receive, an indication 1006 of a set of network-side SBFD resources. The indication 1006 may indicate time-domain elements (e.g., slots or symbols) and frequency-domain elements (e.g., sub-bands) for the set of network-side SBFD resources. Thus, the UE 1004 may be aware of time and frequency information for network-side SBFD operation.

As shown, the network entity 1002 may transmit, and the UE 1004 may receive, a configuration 1008. The configuration 1008 may indicate a set of resources as UE-side SBFD resources. However, the configuration 1008 may omit one or more of a frequency-domain element (e.g., indicating which slots or symbols are UE-side SBFD resources) or a time-domain element (e.g., indicating sub-bands and/or guard bands of UE-side SBFD resources). In some aspects, the UE 1004 may fail to receive the configuration 1008, which may be considered an example of the configuration 1008 omitting both the frequency-domain element and the time-domain element. For example, the UE 1004 may receive an RRC reconfiguration message that does not include a time-domain element or a frequency-domain element. As another example, the UE 1004 may determine that the UE 1004 has received neither a time-domain element nor a frequency-domain element.

As shown, at 1010, the UE 1004 (and optionally the network entity 1002) may perform a communication (which may be an SBFD communication or a UE-side SBFD communication) on the set of resources indicated by the configuration 1008. Additional detail is provided below.

In some aspects, the configuration 1008 includes the time-domain element and not the frequency-domain element. For example, the configuration 1008 may indicate the time-domain element but no frequency-domain element for UE-side SBFD resources. In some aspects, in such cases, the UE 1004 may not perform UE-side SBFD operation in the UE-side SBFD resources. For example, the UE 1004 may perform an SBFD communication or a half-duplex communication in the UE-side SBFD resources. Alternatively, the UE 1004 may perform a UE-side SBFD communication in the UE-side SBFD resources using a default guard band for UE-side SBFD resources. Alternatively, the UE 1004 may perform a UE-side SBFD communication in the UE-side SBFD resources using a set of guard bands indicated by the indication 1006 (e.g., a network-side SBFD resource guard band). Alternatively, the UE 1004 may determine an error case (e.g., may perform half-duplex communication or SBFD communication based on the error case).

In some aspects, the configuration 1008 includes the frequency-domain element and not the time-domain element. For example, the configuration 1008 may indicate the frequency-domain element but no time-domain element for UE-side SBFD resources. In some aspects, in such cases, the UE 1004 may not perform UE-side SBFD operation in the UE-side SBFD resources. For example, the UE 1004 may perform an SBFD communication or a half-duplex communication in the UE-side SBFD resources. Alternatively, the UE 1004 may perform a UE-side SBFD communication in the UE-side SBFD resources. For example, the UE 1004 may assume that all resources (e.g., slots or symbols), indicated by the indication 1006 as network-side SBFD resources, are UE-side SBFD resources, and may perform UE-side SBFD communication in these resources. Alternatively, the UE 1004 may determine an error case (e.g., may perform half-duplex communication or SBFD communication based on the error case).

In some aspects, the configuration 1008 indicates neither the frequency-domain element nor the time-domain element. In some aspects, in such cases, the UE 1004 may not perform UE-side SBFD operation in the UE-side SBFD resources. For example, the UE 1004 may perform an SBFD communication or a half-duplex communication in the UE-side SBFD resources. Alternatively, the UE 1004 may perform UE-side SBFD communication in the UE-side SBFD resources. For example, the UE 1004 may use a default guard band for UE-side SBFD resources or a set of guard bands indicated by the indication 1006 (e.g., a network-side SBFD resource guard band). Additionally, or alternatively, the UE 1004 may perform UE-side SBFD communication in any resource indicated as an SBFD resource by the indication 1006. Additionally, or alternatively, the UE 1004 may perform UE-side SBFD communication on SBFD resources that occur within a default window, where the default window occurs within a network-side SBFD window (e.g., 710) or a set of resources indicated as network-side SBFD resources.

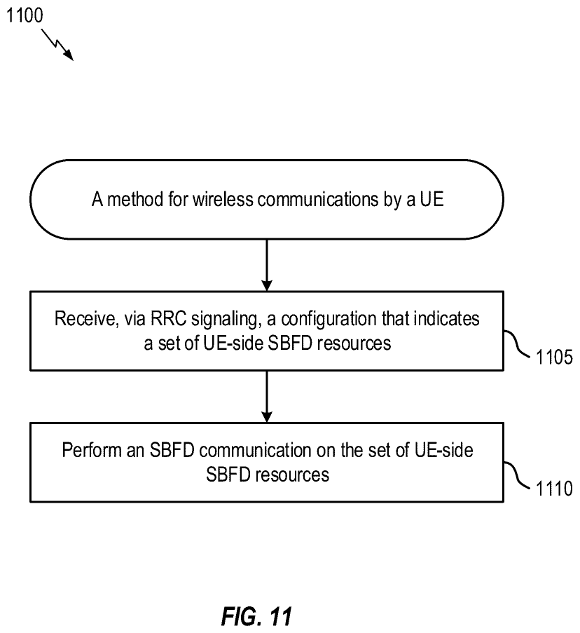

FIG. 11 shows a method 1100 for wireless communications by an apparatus, such as UE 104 of FIG. 1 or UE 304 of FIG. 3.

Method 1100 begins at block 1105 with receiving, via RRC signaling, a configuration that indicates a set of UE-side SBFD resources.

Method 1100 then proceeds to block 1110 with performing an SBFD communication on the set of UE-side SBFD resources.

In some aspects, method 1100 further includes receiving an indication of a network-side SBFD resource, wherein the set of UE-side SBFD resources are associated with a first guard band size and the network-side SBFD resource is associated with a second guard band size.

In some aspects, method 1100 further includes performing unidirectional SBFD communication on the network-side SBFD resource.

In some aspects, block 1105 includes receiving the configuration via a cell-specific configuration while the UE is in an inactive mode or a connected mode.

In some aspects, method 1100 further includes receiving signaling that indicates a modification to the set of UE-side SBFD resources, wherein block 1110 includes performing the SBFD communication in accordance with the modification.

In some aspects, block 1105 includes receiving the configuration via a UE-specific configuration while the UE is in a connected mode.

In some aspects, the configuration indicates a time-domain pattern for the set of UE-side SBFD resources.

In some aspects, method 1100 further includes transmitting assistance information regarding at least one of: a power level for which the SBFD communication is supported, or a shared channel grant type for which the SBFD communication is supported, wherein the method 1100 further comprises receiving a modification to the set of UE-side SBFD resources in accordance with the assistance information.

In some aspects, the modification is via an RRC reconfiguration message.

In some aspects, the modification is via dynamic signaling.

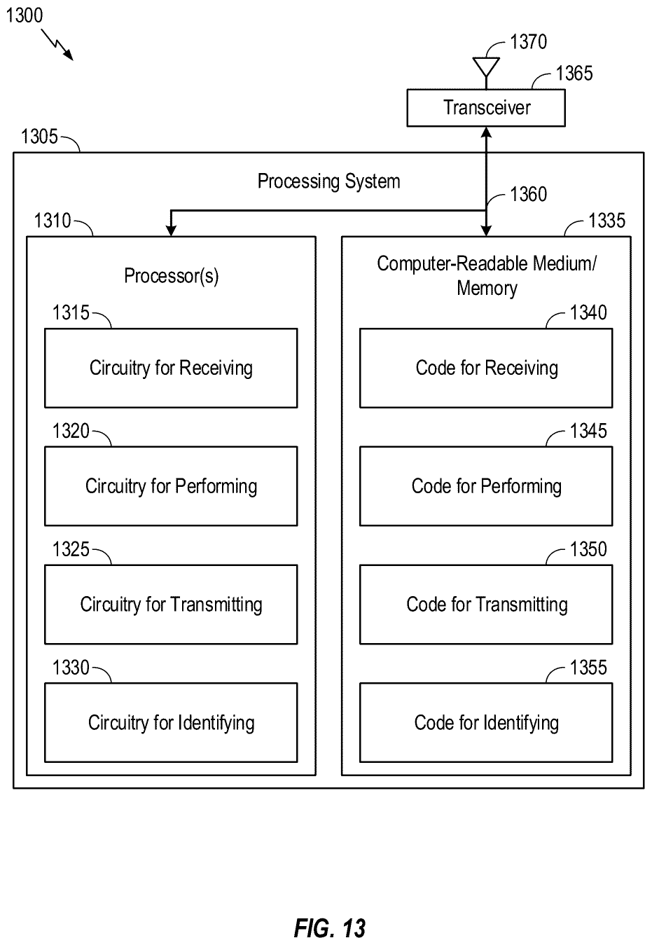

In some aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

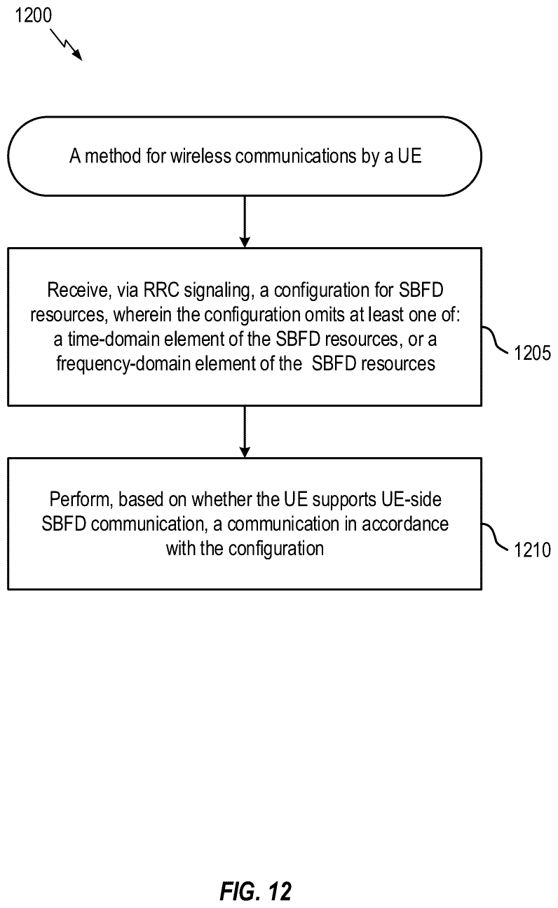

FIG. 12 shows a method 1200 for wireless communications by an apparatus, such as UE 104 of FIG. 1 or UE 304 of FIG. 3.

Method 1200 begins at block 1205 with receiving, via RRC signaling, a configuration for SBFD resources, wherein the configuration omits at least one of: a time-domain element of the SBFD resources, or a frequency-domain element of the SBFD resources. In some aspects, the SBFD resources are indicated as network-side SBFD resources (e.g., as described with respect to FIG. 9). In some aspects, the SBFD resources are indicated as UE-side SBFD resources (e.g., as described with respect to FIG. 10).

Method 1200 then proceeds to block 1210 with performing, based on whether the UE supports UE-side SBFD communication, a communication in accordance with the configuration.

In some aspects, the configuration omits the time-domain element, the UE supports only half-duplex communication, and block 1210 includes performing half-duplex communication in the SBFD resources.

In some aspects, the configuration omits the time-domain element, the UE supports only half-duplex communication, and block 1210 includes performing unidirectional SBFD communication in the SBFD resources according to a default frequency-domain subband.

In some aspects, the configuration omits the time-domain element, the UE supports only half-duplex communication, and block 1210 includes identifying an error associated with the configuration.

In some aspects, the configuration omits the frequency-domain element, the UE supports only half-duplex communication, and block 1210 includes performing half-duplex communication in the SBFD resources.

In some aspects, the configuration omits the frequency-domain element, the UE supports only half-duplex communication, the UE is configured with a time division duplexing pattern, and block 1210 includes performing unidirectional SBFD communication in the SBFD resources in a set of resources associated with the time division duplexing pattern.

In some aspects, the configuration omits the frequency-domain element, the UE supports only half-duplex communication, and block 1210 includes identifying an error associated with the configuration.

In some aspects, the configuration omits both the frequency-domain element and the time-domain element, the UE supports only half-duplex communication, and wherein block 1210 includes performing half-duplex communication in the SBFD resources.

In some aspects, the configuration omits both the frequency-domain element and the time-domain element, the UE supports only half-duplex communication, the UE is configured with a time division duplexing pattern, and block 1210 includes performing unidirectional SBFD communication in the SBFD resources in a set of resources associated with a time division duplexing pattern or a default frequency-domain subband.

In some aspects, the UE supports UE-side SBFD communication, the configuration indicates the SBFD resources as UE-side SBFD resources, the configuration omits the frequency-domain element, and block 1210 includes performing half-duplex communication or unidirectional SBFD communication in the SBFD resources.

In some aspects, the UE supports UE-side SBFD communication, the configuration omits the frequency-domain element, the configuration indicates the SBFD resources as UE-side SBFD resources, and block 1210 includes performing SBFD communication in the UE-side SBFD resources using a default guard band size or a guard band size associated with a network-side SBFD resource.

In some aspects, the UE supports UE-side SBFD communication, the configuration omits the frequency-domain element, and block 1210 includes identifying an error case.

In some aspects, the UE supports UE-side SBFD communication, the configuration indicates the SBFD resources as UE-side SBFD resources, the configuration omits the time-domain element, and block 1210 includes performing half-duplex communication or unidirectional SBFD communication in the UE-side SBFD resources.

In some aspects, the UE supports UE-side SBFD communication, the configuration omits the frequency-domain element, the configuration indicates the SBFD resources as UE-side SBFD resources, and block 1210 includes performing UE-side SBFD communication, in any slot configured as an SBFD slot, using a guard band size associated with the UE-side SBFD resources.

In some aspects, the UE supports UE-side SBFD communication, the configuration omits the time-domain element, and block 1210 includes identifying an error case.

In some aspects, the UE supports UE-side SBFD communication, the configuration indicates the SBFD resources as UE-side SBFD resources, the configuration omits the time-domain element and the frequency-domain element, and block 1210 includes performing half-duplex communication or unidirectional SBFD communication in the UE-side SBFD resources.

In some aspects, the UE supports UE-side SBFD communication, the configuration omits the frequency-domain element and the time-domain element, and block 1210 includes performing UE-side SBFD communication, in any resource (e.g., slot) configured as an SBFD resource (e.g., slot) or in a default window.

In some aspects, the UE-side SBFD communication uses a default guard band size or a guard band size associated with a network-side SBFD resource.

In some aspects, method 1200, or any aspect related to it, may be performed by an apparatus, such as communications device 1300 of FIG. 13, which includes various components operable, configured, or adapted to perform the method 1200. Communications device 1300 is described below in further detail.

Note that FIG. 12 is just one example of a method, and other methods including fewer, additional, or alternative operations are possible consistent with this disclosure.

### Example Communications Device

FIG. 13 depicts aspects of an example communications device 1300 configured for wireless communications. In some aspects, communications device 1300 is a user equipment, such as UE 104 described above with respect to FIG. 1 or UE 304 described with respect to FIG. 3.

The communications device 1300 includes a processing system 1305 coupled to a transceiver 1365 (e.g., a transmitter and/or a receiver). The transceiver 1365 is configured to transmit and receive signals for the communications device 1300 via an antenna 1370, such as the various signals as described herein. The processing system 1305 may be configured to perform processing functions for the communications device 1300, including processing signals received and/or to be transmitted by the communications device 1300.

The processing system 1305 includes one or more processors 1310 and a computer-readable medium/memory 1335. In various aspects, the one or more processors 1310 may be representative of the one or more processors 318 described with respect to FIG. 3. The one or more processors 1310 are coupled to a computer-readable medium/memory 1335 via a bus 1360. In some aspects, the computer-readable medium/memory 1335 may be representative of the one or more memories 320 described with respect to FIG. 3. The computer-readable medium/memory 1335 is a non-transitory computer-readable medium/memory. In certain aspects, the computer-readable medium/memory 1335 is configured to store instructions (e.g., computer-executable code), that when executed by the one or more processors 1310, cause the one or more processors 1310 to perform the method 1100 described with respect to FIG. 11, or any aspect related to it, including any operations described in relation to FIG. 11, and/or the method 1200 described with respect to FIG. 12, or any aspect related to it, including any operations described in relation to FIG. 12. Note that reference to a processor performing a function of communications device 1300 may include one or more processors performing that function of communications device 1300, such as in a distributed fashion.

In the depicted example, computer-readable medium/memory 1335 stores code (e.g., executable instructions), including code for receiving 1340, code for performing 1345, code for transmitting 1350, and code for identifying 1355. Processing of the code 1340-1355 may enable and cause the communications device 1300 to perform the method 1100 described with respect to FIG. 11, or any aspect related to it, and/or the method 1200 described with respect to FIG. 12, or any aspect related to it.

The one or more processors 1310 include circuitry configured to implement (e.g., execute) the code stored in the computer-readable medium/memory 1335, including circuitry for receiving 1315, circuitry for performing 1320, circuitry for transmitting 1325, and circuitry for identifying 1330. Processing with circuitry 1315-1330 may enable and cause the communications device 1300 to perform the method 1100 described with respect to FIG. 11, or any aspect related to it, and/or the method 1200 described with respect to FIG. 12, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1365 and/or antenna 1370 of the communications device 1300 in FIG. 13, and/or one or more processors 1310 of the communications device 1300 in FIG. 13. Means for communicating, receiving or obtaining may include the one or more transceivers 324, one or more antennas 322, and/or processing system 316 of the UE 304 illustrated in FIG. 3, transceiver 1365 and/or antenna 1370 of the communications device 1300 in FIG. 13, and/or one or more processors 1310 of the communications device 1300 in FIG. 13.

### EXAMPLE CLAUSES

Implementation examples are described in the following numbered clauses:

Clause 1: A method for wireless communications by a UE comprising: receiving, via RRC signaling, a configuration that indicates a set of UE-side SBFD resources; and performing an SBFD communication on the set of UE-side SBFD resources.

Clause 2: The method of Clause 1, further comprising receiving an indication of a network-side SBFD resource, wherein the set of UE-side SBFD resources are associated with a first guard band size and the network-side SBFD resource is associated with a second guard band size.

Clause 3: The method of Clause 2, further comprising performing unidirectional SBFD communication on the network-side SBFD resource.

Clause 4: The method of any one of Clauses 1-3, wherein receiving the configuration comprises receiving the configuration via a cell-specific configuration while the UE is in an inactive mode or a connected mode.

Clause 5: The method of Clause 4, further comprising receiving signaling that indicates a modification to the set of UE-side SBFD resources, wherein performing the SBFD communication on the set of UE-side SBFD resources comprises performing the SBFD communication in accordance with the modification.

Clause 6: The method of any one of Clauses 1-5, wherein receiving the configuration comprises receiving the configuration via a UE-specific configuration while the UE is in a connected mode.

Clause 7: The method of any one of Clauses 1-6, wherein the configuration indicates a time-domain pattern for the set of UE-side SBFD resources.

Clause 8: The method of any one of Clauses 1-7, further comprising transmitting assistance information regarding at least one of: a power level for which the SBFD communication is supported, or a shared channel grant type for which the SBFD communication is supported, wherein the method further comprises receiving a modification to the set of UE-side SBFD resources in accordance with the assistance information.

Clause 9: The method of Clause 8, wherein the modification is via an RRC reconfiguration message.

Clause 10: The method of Clause 8, wherein the modification is via dynamic signaling.

Clause 11: A method for wireless communications by a UE comprising: receiving, via RRC signaling, a configuration for UE-side SBFD resources, wherein the configuration omits at least one of: a time-domain element of the UE-side SBFD resources, or a frequency-domain element of the UE-side SBFD resources; and performing, based on whether the UE supports UE-side SBFD communication, a communication in accordance with the configuration.

Clause 12: The method of Clause 11, wherein the configuration omits the time-domain element, the UE supports only half-duplex communication, and performing the communication comprises performing half-duplex communication in the UE-side SBFD resources.

Clause 13: The method of any one of Clauses 11-12, wherein the configuration omits the time-domain element, the UE supports only half-duplex communication, and performing the communication comprises performing unidirectional SBFD communication in the UE-side SBFD resources according to a default frequency-domain subband.

Clause 14: The method of any one of Clauses 11-13, wherein the configuration omits the time-domain element, the UE supports only half-duplex communication, and performing the communication comprises identifying an error associated with the configuration.

Clause 15: The method of any one of Clauses 11-14, wherein the configuration omits the frequency-domain element, the UE supports only half-duplex communication, and performing the communication comprises performing half-duplex communication in the UE-side SBFD resources.

Clause 16: The method of any one of Clauses 11-15, wherein the configuration omits the frequency-domain element, the UE supports only half-duplex communication, the UE is configured with a time division duplexing pattern, and performing the communication comprises performing unidirectional SBFD communication in the UE-side SBFD resources in a set of resources associated with the time division duplexing pattern.

Clause 17: The method of any one of Clauses 11-16, wherein the configuration omits the frequency-domain element, the UE supports only half-duplex communication, and performing the communication comprises identifying an error associated with the configuration.

Clause 18: The method of any one of Clauses 11-17, wherein the configuration omits both the frequency-domain element and the time-domain element, the UE supports only half-duplex communication, and wherein performing the communication comprises performing half-duplex communication in the UE-side SBFD resources.

Clause 19: The method of any one of Clauses 11-18, wherein the configuration omits both the frequency-domain element and the time-domain element, the UE supports only half-duplex communication, the UE is configured with a time division duplexing pattern, and performing the communication comprises performing unidirectional SBFD communication in the UE-side SBFD resources in a set of resources associated with a time division duplexing pattern or a default frequency-domain subband.

Clause 20: The method of any one of Clauses 11-19, wherein the UE supports UE-side SBFD communication, the configuration omits the frequency-domain element, and performing the communication comprises performing half-duplex communication or unidirectional SBFD communication in the UE-side SBFD resources.

Clause 21: The method of any one of Clauses 11-20, wherein the UE supports UE-side SBFD communication, the configuration omits the frequency-domain element, and performing the communication comprises performing SBFD communication in the UE-side SBFD resources using a default guard band size or a guard band size associated with a network-side SBFD resource.

Clause 22: The method of any one of Clauses 11-21, wherein the UE supports UE-side SBFD communication, the configuration omits the frequency-domain element, and performing the communication comprises identifying an error case.

Clause 23: The method of any one of Clauses 11-22, wherein the UE supports UE-side SBFD communication, the configuration omits the time-domain element, and performing the communication comprises performing half-duplex communication or unidirectional SBFD communication in the UE-side SBFD resources.

Clause 24: The method of any one of Clauses 11-23, wherein the UE supports UE-side SBFD communication, the configuration omits the frequency-domain element, and performing the communication comprises performing UE-side SBFD communication, in any slot configured as an SBFD slot, using a guard band size associated with the UE-side SBFD resources.

Clause 25: The method of any one of Clauses 11-24, wherein the UE supports UE-side SBFD communication, the configuration omits the time-domain element, and performing the communication comprises identifying an error case.

Clause 26: The method of any one of Clauses 11-25, wherein the UE supports UE-side SBFD communication, the configuration omits the time-domain element and the frequency-domain element, and performing the communication comprises performing half-duplex communication or unidirectional SBFD communication in the UE-side SBFD resources.

Clause 27: The method of any one of Clauses 11-26, wherein the UE supports UE-side SBFD communication, the configuration omits the frequency-domain element and the time-domain element, and performing the communication comprises performing UE-side SBFD communication, in any slot configured as an SBFD slot or in a default window.

Clause 28: The method of Clause 27, wherein the UE-side SBFD communication uses a default guard band size or a guard band size associated with a network-side SBFD resource.

Clause 29: One or more apparatuses, comprising: one or more memories comprising executable instructions; and one or more processors configured to execute the executable instructions and cause the one or more apparatuses to perform a method in accordance with any one of Clauses 1-28.

Clause 30: One or more apparatuses configured for wireless communications, comprising: one or more memories; and one or more processors, coupled to the one or more memories, configured to cause the one or more apparatuses to perform a method in accordance with any one of Clauses 1-28.

Clause 31: One or more apparatuses configured for wireless communications, comprising: one or more memories; and one or more processors, coupled to the one or more memories, configured to perform a method in accordance with any one of Clauses 1-28.

Clause 32: One or more apparatuses, comprising means for performing a method in accordance with any one of Clauses 1-28.

Clause 33: One or more non-transitory computer-readable media comprising executable instructions that, when executed by one or more processors of one or more apparatuses, cause the one or more apparatuses to perform a method in accordance with any one of Clauses 1-28.

Clause 34: One or more computer program products embodied on one or more computer-readable storage media comprising code for performing a method in accordance with any one of Clauses 1-28.

Clause 35: One or more apparatuses configured for wireless communications, comprising: a processing system that includes one or more processors and one or more memories coupled with the one or more processors, the processing system configured to cause the one or more apparatuses to perform a method in accordance with any one of Clauses 1-28.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
receive, via radio resource control (RRC) signaling, a configuration that indicates a set of UE-side sub-band full duplex (SBFD) resources; and
perform an SBFD communication on the set of UE-side SBFD resources.

2. The apparatus of claim 1, wherein the processing system is configured to cause the UE to receive an indication of a network-side SBFD resource, wherein the set of UE-side SBFD resources are associated with a first guard band size and the network-side SBFD resource is associated with a second guard band size.

3. The apparatus of claim 2, wherein the processing system is configured to cause the UE to perform unidirectional SBFD communication on the network-side SBFD resource.

4. The apparatus of claim 1, wherein to cause the UE to receive the configuration, the processing system is configured to cause the UE to receive the configuration via a cell-specific configuration while the UE is in an inactive mode or a connected mode.

5. The apparatus of claim 4, wherein the processing system is configured to cause the UE to receive signaling that indicates a modification to the set of UE-side SBFD resources, wherein to cause the UE to perform the SBFD communication on the set of UE-side SBFD resources, the processing system is configured to cause the UE to perform the SBFD communication in accordance with the modification.

6. The apparatus of claim 1, wherein to cause the UE to receive the configuration, the processing system is configured to cause the UE to receive the configuration via a UE-specific configuration while the UE is in a connected mode.

7. The apparatus of claim 1, wherein the configuration indicates a time-domain pattern for the set of UE-side SBFD resources.

8. The apparatus of claim 1, wherein the processing system is configured to cause the UE to transmit assistance information regarding at least one of:
a power level for which the SBFD communication is supported, or
a shared channel grant type for which the SBFD communication is supported, wherein the processing system is further configured to cause the UE to receive a modification to the set of UE-side SBFD resources in accordance with the assistance information.

9. The apparatus of claim 8, wherein the modification is via an RRC reconfiguration message.

10. The apparatus of claim 8, wherein the modification is via dynamic signaling.

11. An apparatus for wireless communications, comprising a processing system that includes one or more processors and one or more memories coupled with the one or more processors, the processing system configured to cause a user equipment (UE) to:
receive, via radio resource control (RRC) signaling, a configuration for sub-band full duplex (SBFD) resources, wherein the configuration omits at least one of:
a time-domain element of the SBFD resources, or
a frequency-domain element of the SBFD resources; and
perform, based on whether the UE supports UE-side SBFD communication, a communication in accordance with the configuration.

12. The apparatus of claim 11, wherein the configuration omits the time-domain element, the UE supports only half-duplex communication, and to cause the UE to perform the communication, the processing system is configured to cause the UE to perform half-duplex communication in the SBFD resources.

13. The apparatus of claim 11, wherein the configuration omits the time-domain element, the UE supports only half-duplex communication, and to cause the UE to perform the communication, the processing system is configured to cause the UE to perform unidirectional SBFD communication in the SBFD resources according to a default frequency-domain subband.

14. The apparatus of claim 11, wherein the configuration omits the frequency-domain element, the UE supports only half-duplex communication, and to cause the UE to perform the communication, the processing system is configured to cause the UE to perform half-duplex communication in the SBFD resources.

15. The apparatus of claim 11, wherein the configuration omits the frequency-domain element, the UE supports only half-duplex communication, the UE is configured with a time division duplexing pattern, and to cause the UE to perform the communication, the processing system is configured to cause the UE to perform unidirectional SBFD communication in the SBFD resources in a set of resources associated with the time division duplexing pattern.

16. The apparatus of claim 11, wherein the configuration omits both the frequency-domain element and the time-domain element, the UE supports only half-duplex communication, and wherein to cause the UE to perform the communication, the processing system is configured to cause the UE to perform half-duplex communication in the SBFD resources.

17. The apparatus of claim 11, wherein the configuration omits both the frequency-domain element and the time-domain element, the UE supports only half-duplex communication, the UE is configured with a time division duplexing pattern, and to cause the UE to perform the communication, the processing system is configured to cause the UE to perform unidirectional SBFD communication in the SBFD resources in a set of resources associated with a time division duplexing pattern or a default frequency-domain subband.

18. The apparatus of claim 11, wherein the UE supports UE-side SBFD communication, the configuration indicates the SBFD resources as UE-side SBFD resources, the configuration omits the frequency-domain element, and to cause the UE to perform the communication, the processing system is configured to cause the UE to perform half-duplex communication or unidirectional SBFD communication in the UE-side SBFD resources.

19. The apparatus of claim 11, wherein the UE supports UE-side SBFD communication, the configuration indicates the SBFD resources as UE-side SBFD resources, the configuration omits the frequency-domain element, and to cause the UE to perform the communication, the processing system is configured to cause the UE to perform SBFD communication in the UE-side SBFD resources using a default guard band size or a guard band size associated with a network-side SBFD resource.

20. A method for wireless communications by a user equipment (UE) comprising:
receiving, via radio resource control (RRC) signaling, a configuration that indicates a set of UE-side sub-band full duplex (SBFD) resources; and
performing an SBFD communication on the set of UE-side SBFD resources.
